(19) United States
(12) Patent Application Publication
(10) Pub. No.: US 2015/0256493 A1
(43) Pub. Date: Sep. 10, 2015

(54) System and Method for Document Processing

(71) Applicant: David Wilson, Scottsdale, AZ (US)

(72) Inventor: David Wilson, Scottsdale, AZ (US)

(21) Appl. No.: 14/198,554

(22) Filed: Mar. 5, 2014

(51) Int. Cl. H04L 12/58; G06F 17/30

(52) U.S. Cl. CPC H04L 51/08; G06F 17/30011

(57) ABSTRACT

A method and system are provided for the delivery, processing, and distribution of digital content with a computational interface for one or more users. A user sends a message and attached document to a computer-based system with natural language instructions in the message subject or body, or as scripts. After user authentication, the subject and body of the message are interpreted and document processing activities to be performed are identified (e.g., convert to PDF, delete blank pages, translate to Spanish, etc.). With the document processing activities identified, the attached or referenced document is processed in accordance with the instructions by the document processing server. Other applications and software may be invoked (e.g., via APIs) and used during the document processing tasks. The system can be used to store, process and deliver resulting documents and images and other output information in a hosted or Software As A Service (SAAS) environment.

### BACKGROUND OF THE INVENTION

1. Technical Field

The present invention relates generally to the field of document processing and more specifically relates to systems and methods for creating and applying instructions for processing documents in a cloud-based environment.

2. Background Art

With the widespread adoption and availability of the Internet, the Internet has become a valuable tool for research, shopping, entertainment, and other activities. Software As A Service (SAAS) systems are readily available for both consumer and commercial application and the growth of SAAS systems is robust and steady. Many SAAS systems are “cloud based” which simply means that the infrastructure and services are provided via a computer network such as the Internet and users can access the cloud-based services from any location where there is a connection to the network. Some particularly valuable tools made available via the Internet are the various business related processes that involve the automation of tasks and activities that were formerly done by humans. For example, business “workflow” processes may be enhanced by the use of SAAS tools and resources.

Workflow describes the actions that are taken by a person(s) to accomplish a given task. The required tasks may be of short duration with few if any complicated actions, or the required tasks may be of a relatively long duration and involve many complicated actions. Often, during the accomplishment of a given task or set of tasks, data needs to be gathered, received, collected and stored. Additionally, most business workflow processes involve the exchange of data between individuals and organizations in order to accomplish various tasks. These tasks will often include the collection and dissemination of information contained in various documents (e.g., memos, reports, emails, drawings, etc.).

Ideally, the acquisition, transmission, collection and storage of information during a workflow should occur at the appropriate time with a minimal amount of effort or disruption to the other actions in the workflow. However, despite the advances in computing, computer-driven data acquisition and information retrieval that have occurred over the recent past, certain information intensive workflows have not benefited as expected. Generally, these workflows include a variety of manual actions that are highly variable based on the skills and abilities of the person engaged in the workflow. Additionally, creating document workflow instructions can be a complex and relatively unintuitive process.

For example, certain information may be available, but it may be in the wrong location and in the wrong data format. This may necessitate an interruption in an otherwise automated workflow while the information is transformed into an alternative format and then transmitted to the appropriate person or entity for additional processing.

An additional limitation is the relative complexity of the installation and adoption for most applications used to process documents in standard workflow systems and processes. These, and other similar limitations, make the current methods of document processing less efficient and effective than it might be. Accordingly, without improvements in the current systems, procedures, and methods for processing documents, the ability to effectively and efficiently complete certain workflow processes will continue to be sub-optimal.

### BRIEF SUMMARY OF THE INVENTION

A method and system are provided for the delivery, processing, and distribution of digital content with a computational interface for one or more users. A user sends a message and an attached document or reference to a document to a computer-based system with natural language instructions in the message subject or body, or as scripts. The subject and body of the message are interpreted and document processing activities to be performed are identified (e.g., convert to PDF, delete blank pages, translate to Spanish, etc.).

With the document processing activities identified, the attached document is processed in accordance with the instructions by the document processing server. Other applications and software may be invoked (e.g., via APIs) and used during the document processing tasks. The system can be used to store, process and deliver resulting documents and images and other output information in a hosted or Software As A Service (SAAS) environment. The system and method may be provided in a Software As A Service (SAAS) environment, using a “freemium” model or more traditional subscription model with pricing based on page count volume or other metrics.

The most preferred embodiments of the document processing system and method provides a platform for data input, digital document processing, and document delivery utilizing existing office resources and natural language input through standard email or text messaging procedures. The document processing system and method uses a wired or wireless device to identify or provide attached documents or images and define operations and delivery using a natural language text from the wired desktop or wireless handheld device. The document processing system analyses the document service requests, authenticates a user's subscription, performs the document services and delivers the resulting document to the user's email address, or onto a server, which can be made available to each worker. Uniquely, the document processing system of the present invention analyzes and stores the delivery, and/or document processing tasks using natural language parsing. The most preferred embodiments of the present invention utilize email or text messaging input along with a digital documents to describe the desired delivery and document processes to perform. The analysis and evaluation apparatus extracts common words and concepts that are evaluated and stored, and performs the identified tasks to process, retrieve and deliver the processed digital documents.

### BRIEF DESCRIPTION OF THE FIGURES

The preferred embodiments of the present invention will hereinafter be described in conjunction with the appended drawings, wherein like designations denote like elements, and:

FIG. 1 is a schematic diagram of a computer-based system for transmitting and processing one or more documents using natural language instructions in accordance with a preferred exemplary embodiment of the present invention;

FIG. 2 is a block diagram of a server (computer) used for transmitting and processing one or more documents using natural language instructions in accordance with a preferred exemplary embodiment of the present invention;

FIG. 3 is a block diagram of a message processing queue containing one or more documents scheduled for processing using natural language instructions in accordance with a preferred exemplary embodiment of the present invention;

FIG. 3A is a block diagram of a message processing queue containing one or more documents scheduled for processing using natural language instructions in accordance with an alternative preferred exemplary embodiment of the present invention;

FIG. 4 is a flow chart of a method for preparing one or more documents for processing using natural language instructions in accordance with a preferred exemplary embodiment of the present invention is depicted;

FIG. 5 is flow chart of a method for processing one or more documents using natural language instructions in accordance with a preferred exemplary embodiment of the present invention is depicted;

FIG. 6 is a block diagram representing a user account in a system for processing a document using natural language instructions in accordance with a preferred exemplary embodiment of the present invention; and

FIG. 7 is a block diagram of a document naming schema for use in conjunction with a system for processing a document using natural language instructions in accordance with a preferred exemplary embodiment of the present invention.

### DETAILED DESCRIPTION OF THE INVENTION

The system and method of the present invention are used to provide a utility for processing documents via the Internet. Users can send a message containing natural language instructions on tasks to be performed to an attached or referenced document to a SAAS provider. The document processing tasks can be such things as convert the document to a .pdf file, read barcodes contained in the document, data mine the document for key words, encrypt the document, etc. In at least some preferred embodiments of the present invention, an authentication or security mechanism validates the user to ensure that the user is authorized to access the document processing service and has a valid account to proceed. If the user account can be validated, the documents attached to or referenced by the message will be processed in accordance with the instructions. If the user account cannot be validated, the documents attached to or referenced by the letter will not be processed. In either case, the system is configured to provide status updates and notifications to the user. Once the documents have been processed, the documents can be sent back to the user (e.g., via email, fax, etc.) or stored in the user's account for later retrieval or transferred to a user-designated delivery device or service (e.g. a box.net account, a Dropbox® account, a Google Drive® account, FTP server account, etc.).

For purposes of this disclosure, the following definitions will be used to describe certain components of the system and methods disclosed herein.

Input Submitting Device (“ISD”)

An ISD is a wired or wireless computation device used to submit documents or images through standard email delivery methods. It includes personal computers, smart phones, tablets, eBooks and other computation devices with Internet connectivity, a graphics screen, memory and computational capabilities. The ISD may be commercially available products, such as, but not limited to PDAs, advanced cell phones, laptop, tablet and desktop computers, and the like.

Document Processing Device (“DPD”)

An DPD is any electronic computing device that is capable of receiving and storing information from an ISD. The DPD may also be used to access, store and utilize other files, such as documents, graphics, and tables, to run other applications, such as standard document processing, spreadsheet, database, presentation and communication applications, interact with other computers and the like through an intranet or the internet, capture, store and use information, documents or graphics from other input devices, etc. Multiple ISD systems may transmit data, information and instructions to one or multiple computing devices.

Natural Language Text Instructions (“NLTI”)

NLTI comprises a set of natural language text-based phrases that identify document and image based tasks in a descriptive and natural fashion. This includes shorthand and abbreviations, such as those commonly used in text messaging applications. NLTI input for document processing may be derived from a variety of sources including voice transcription/interpretation, text input, optical character recognition (“OCR”), text parsing, etc.

Document(s)

Documents refers to individual electronic files or sets of electronic files in the form of documents or image based files used as input data and delivered from an ISD to a DPD.

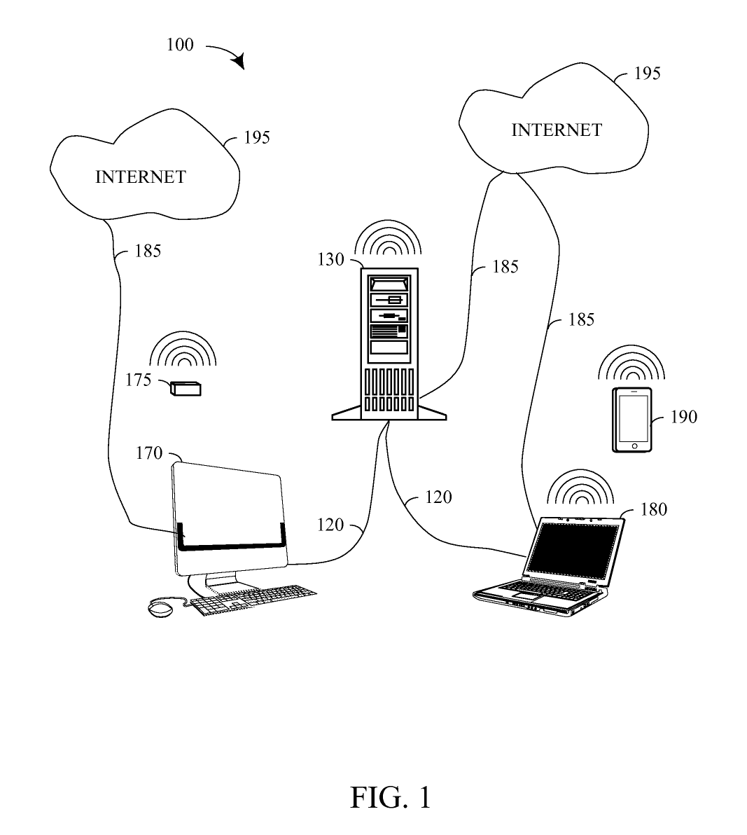

Referring now to FIG. 1, a computer-based system 100 for document processing in accordance with a preferred exemplary embodiment of the present invention comprises: a data server (computer) 130; at least one of a desktop computer 170 or a laptop computer 180; a wireless communication device 175; and a mobile communication device 190 (e.g., a smartphone or personal digital assistant “PDA”) all connected or coupled via a local area network 120 to the Internet 195 via an Internet connection 185. Each of desktop computer 170, laptop computer 180, and mobile communication device 190 may be considered as an Input and Submitting Device (“ISD”).

Taken together, the components of computer-based system 100 provide a platform for quickly and efficiently preparing and processing documents using natural language instructions from a wide variety of sources for a wide variety of purposes. Computer-based system 100 provides a mechanism for individuals and organizations to efficiently and effectively manipulate and process documents without the often complex, time-consuming and inefficient manual methods associated with traditional document processing tools.

In the most preferred embodiments of the present invention, computer-based system 100 is configured as a system that will be used to process documents for personal, business and commercial purposes. However, those skilled in the art will recognize that the various preferred embodiments of the present invention have additional application in other, unrelated fields. For example, any field of endeavor where large numbers of documents need to be processed and stored would be well suited for adoption of one or more preferred embodiments of the present invention.

Network 120 represents any suitable computer communication link or similar communication mechanism, including some combination of a hardwired connection, an internal or external bus, a connection for telephone access via a modem, standard co-axial cable lines, high-speed T1 line, radio, infrared or other wireless communication methodologies (e.g., “Bluetooth,” infrared (IR), etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 might suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard Internet connection 185 between at least some of the components of computer-based system for providing optimized message creation and delivery 100 for providing access to additional network resources and other remote locations. Network 120 provides for communication between the various components of computer-based system 100 and allows for relevant information to be transmitted from device to device. In this fashion, a user of computer-based system 100 can quickly and easily gain access to the relevant data and information utilized to create natural language instructions and transmit documents for automated processing as described in conjunction with the various preferred embodiments of the present invention.

In the most preferred embodiments of the present invention, network 120 is configured to provide relatively high-speed transmission of textual information, images, audio and video data and signals, and also comprises at least an Internet connection 185 for transmission of data captured by one or more computers 170 or 180.

In addition to the other components shown in FIG. 1, an optional wireless communication access device 175 may be communicatively coupled to network 120 and represents any type of wireless communication mechanism that is known to those skilled in the art to provide for wireless communication between network 120 and the various devices associated with network 120, including desktop computer 170, laptop computer 180 and as well as mobile communication device 190. The most preferred embodiments of an acceptable wireless communication access device may comprise any type of wireless bridge, wireless router, “mi-fi” or wi-fi “hotspot.”

Regardless of the specific components, physical nature, and topology, network 120 serves to logically and communicatively link the physical components of computer-based system 100, thereby enabling stable and consistent communication between the components. This is especially important because in many preferred embodiments of the present invention, data server 130, desktop computer 170, and laptop computer 180 may be geographically remote and/or physically separated from each other.

Data server 130 represents a relatively powerful computer system that is made available to desktop computer 170, laptop computer 180, and/or mobile communication device 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art. For purposes of this disclosure, data server 130 may be considered a Document Processing Device (“DPD”).

Desktop computer 170 may be any type of computer system known to those skilled in the art that is capable of being configured for use with computer-based system 100 as described herein. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, desktop computer 170 may be linked (via wired or wireless connection) to its own LAN or WAN and have access to one or more additional data servers (not shown this FIG.).

Similarly, laptop computer 180 may be any type of relatively lightweight portable computer system known to those skilled in the art that is capable of being configured for use with computer-based system 100 as described herein. This includes tablet computers (e.g., iPad®), pen-based computers and the like. Computer 180 may also be configured to allow the transmission and reception of audio signals, messages, communications, and various types of alerts via server 130 and network 120.

Additionally, netbooks, tablets, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to its own data server (not shown this FIG.).

In general, the communication between devices associated with data server 130 will be data associated with one or more documents and the associated processing instructions. The users of desktop computer 170 and/or laptop computer 180 may be program administrators, managers, teachers, community members, parents and students who are seeking to create and provide access to information that will optimized for display on mobile devices such as mobile communication device 190. Additionally, various related entities such as local and regional governments, commercial enterprises, municipalities, and their employers and agents may also have access to one or more databases located on data server 130 via desktop computer 170 and/or laptop computer 180.

It should be noted that while FIG. 1 shows only a single desktop computer 170 and a single laptop computer 180, it is anticipated that the most preferred embodiments of the present invention will comprise dozens, hundreds, or even thousands of computers 170 and laptop computers 180. Each of these computers 170 and 180 will be configured to access data server 130 in an appropriately secure way so as to accomplish the specific objectives of the user of the desktop computer 170 or laptop computer 180.

For example, a user located in a remote location may use desktop computer 170 or laptop computer 180 to transmit one or more messages containing documents and document processing instructions to data server 130 for processing. Data server 130, in turn, may store and transmit one or more processed documents back to the user or to some other location and/or process for additional processing. Similarly, other users may simultaneously send additional messages with additional document for processing in like manner. Data server 130 will be configured to process these messages and the associated documents, using natural language instructions associated with each message.

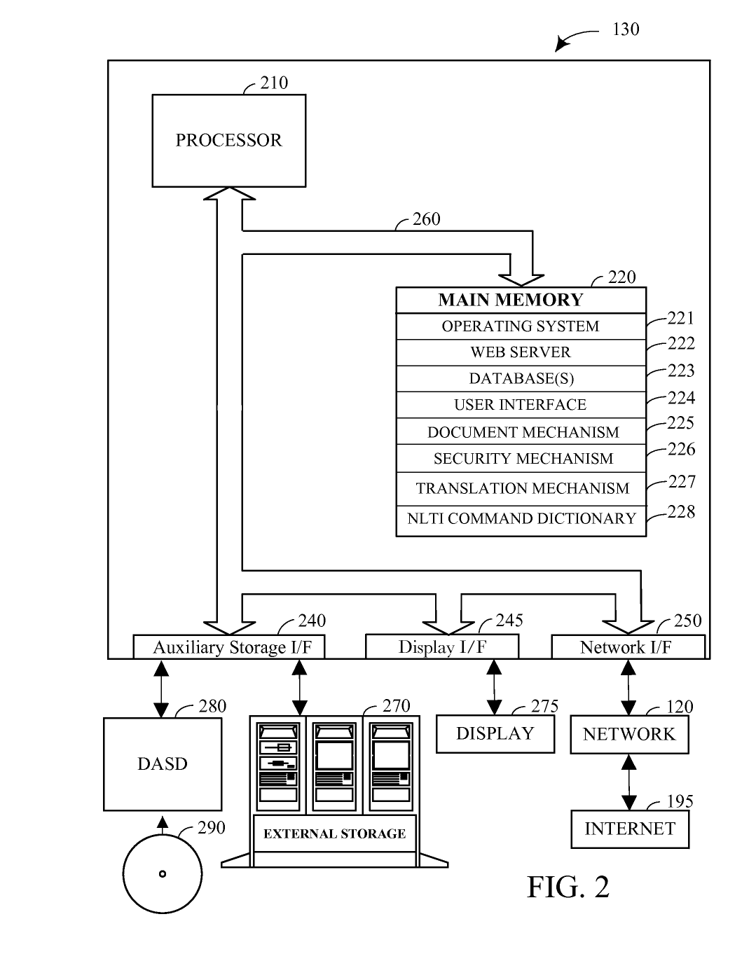

In the most preferred embodiments of the present invention, multiple desktop computers 170 and multiple laptop computers 180 will all be configured to communicate simultaneously with data server 130 and with each other via network 120. In addition, the most preferred embodiments of the present invention include a Software as a Service (SAAS) or Platform as a Service (PAAS) environment where data server 130 may be operated in a hosted operation. In this fashion, multiple desktop computers 170 and laptop computers 180 will have access to data server 130 and the databases stored thereon via a global computer network such as Internet 195. Data server 130 is further described below in conjunction with FIG. 2 below.

An optional printer and an optional fax machine (not shown this FIG.) may also be deployed for various hard copy data output requirements and may be considered to be any standard peripheral devices used for transmitting or outputting paper-based version of website content generated in conjunction with the operation of computer-based system 100 (e.g., reports, communications, statistical analyses, automated letters, etc.). Finally, it should be noted that the optional printer and the optional fax machine are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

Mobile communication device 190 is representative of any type of cellular device, wi-fi or Internet enabled mobile communication device that may be communicatively coupled to computer-based system 100. This includes, for example, personal digital assistants (“PDAs”), Windows® mobile phone devices, Android® OS devices, Palm® OS devices, Pocket PC® devices, the Apple® iPod Touch®, the Apple® iPhone® and other various types of smartphones and portable communication devices, including tablets. Those skilled in the art will recognize these various devices and others that are suitable for deployment as mobile communication device 190. While somewhat less powerful than computers 170 and 180, mobile communication device 190 may also be configured to wirelessly communicate with data server 130 via network 120 to send and receive communications and data to and from data server 130. Given the standard functionality for devices that may be deployed as mobile communication device 190, this communication capability be provided by a wireless Internet connection (e.g. “wi-fi” or “wi-max”) or a Bluetooth® connection as well as LTE and other cellular data communication networks.

Those skilled in the art will recognize that FIG. 1 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that needs to be transferred from a database to the user of computer-based system 100.

Referring now to FIG. 2, data server 130 of FIG. 1 in accordance with a preferred embodiment of the present invention represents one of many commercially available computer systems and those skilled in the art will appreciate that the methods and system of the present invention apply equally to any computer system, regardless of the specific operating system and regardless of whether the computer system is a traditional computer, a complicated multi-user computing device or a single user device such as a personal computer or workstation.

Data server 130 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although data server 130 depicted in FIG. 2 contains only a single processor 210 and a single bus 260, it should be understood that the present invention applies equally to computer systems having multiple processors and multiple system buses.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a non-volatile DVD or CD disk 290.

Display interface 245 is used to directly connect one or more displays 275 to data server 130. Displays 275 provide system administrators and users the ability to communicate with data server 130. Additionally, in certain preferred embodiments, data server 130 may have an integrated display 275.

Network interface 250 is used to connect data server 130 to network 120 and computer-based system 100, including computer 170 and computer 180 of FIG. 1. Network interface 250 broadly represents any suitable way to interconnect electronic devices, regardless of whether the network comprises present day analog and/or digital techniques or via some networking mechanism of the future.

It is important to note that while the present invention has been (and will continue to be) described in the context of a fully functional computer system with certain application software, those skilled in the art will appreciate that the various software mechanisms of the present invention are capable of being distributed as a program product in conjunction with an article of manufacture comprising software stored on a computer readable storage medium in a variety of forms, and that the various preferred embodiments of the present invention applies equally regardless of the particular type or storage medium used to actually carry out the distribution. Examples of computer readable storage media include: non-volatile and non-transitory recordable type media such as DVD and CD ROMS disks (e.g., disk 290), and transmission type media such as digital and analog communication links, including wireless communication links.

Main memory 220 suitably contains an operating system 221, a web server 222, one or more databases 223, a user interface 224, a document mechanism 225, a security mechanism 226, and a translation mechanism 227. The term “memory” as used herein refers to any storage location in the virtual memory space of data server 130.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Web server 222 provides access, including a user interface, to allow individuals and entities to interact with graphical user interface 224, including via network 120 of FIG. 1.

Database 223 is representative of any suitable database known to those skilled in the art. In the most preferred embodiments of the present invention, database 223 will comprise a plurality of information that may be useful to an organization or individual that wants to provide for efficient and effective document processing in conjunction with a preferred embodiment of computer-based system 100 of FIG. 1.

Graphical user interface 224 is a software component that provides the users of computer-based system 100 of FIG. 1 a means for interacting with the various components of computer-based system for processing documents in accordance with a preferred exemplary embodiment of the present invention. In at least some of the most preferred embodiments of the present invention, graphical user interface 224 is a web browser based interface, accessible to the users of computer-based system 100 via any standard web browser from any computer that is connected to the Internet. Additional details on graphical user interface 224 are presented below.

Additionally, at least one preferred embodiment of the present invention comprises a graphical user interface deployed on a mobile communication device 190. In this embodiment, a graphical user interface may be offered via an “app” customized for mobile communication device 190 or via a web browser based interface provides a connection to data server 130, allowing the user of mobile communication device 190 to access document mechanism 225 and database 223 will be accessible and customizable via the graphical user interface provided in conjunction with mobile communication device 190.

Database 223 may also be used to store user data (e.g., user profiles and account information, website preferences, organization profiles, etc.) containing detailed information about each user or group of users, including user phone numbers, email addresses, permissions, home and work addresses, etc.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 might also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented. External storage of database 223 specifically includes various Internet-based storage options such as Google Drive®, OneDrive®, DropBox®, etc.

The most preferred embodiments of computer-based system 100 of FIG. 1 will include a document mechanism 225 in main memory 220. Document mechanism 225 will generally comprise a series of task-oriented routines (e.g., document parsing tools, data and content transformation tools, etc.). Document mechanism 225 is an automated programmable system that is capable of automatically processing the messages and associated document processing instructions from users who transmit one or more messages comprising documents and document processing instructions to server 130.

In the most preferred embodiments of the present invention, document mechanism 225 will monitor an email server on a periodic basis to receive email messages that provide NLTI instructions for processing one or more documents. When an email message is received, document mechanism 225 will process a document attached to or referenced by the email message using one or more NLTI instructions associated with the email. The NLTI instructions may be included in one or more of the subject line for the email, included as a text attachment to the email, included as an audio file attached to the email, etc.

In addition, the most preferred embodiments of the present invention comprise security mechanism 226 for verifying access to the data and information contained in and transmitted to and from data server 130 (e.g., user identity and authentication data, etc.). Security mechanism 226 may be incorporated into operating system 221 and/or web server 222. Additionally, security mechanism 226 may also provide encryption capabilities for other components of computer-based system 100 of FIG. 1, thereby enhancing the robustness of computer-based system 100 of FIG. 1. Security mechanism 226 is most preferably configured to protect the integrity and security of the information transmitted via network 120 of FIG. 1.

Further, depending on the type and quantity of information stored in database 223 and accessed by graphical user interface 224, security mechanism 226 may provide different levels of security and/or encryption for different computer systems 170 and 180 of FIG. 1 and the information stored in database 223. In some preferred embodiments of the present invention, security mechanism 226 may be contained in or implemented in conjunction with certain hardware components (not shown this FIG.) such as hardware-based firewalls, switches, dongles, and the like.

Translation mechanism 227 is a software program or mechanism that is configured to work cooperatively with document mechanism 225 to process documents received by data server 130. For example, translation mechanism 227 may be a third party software program that is specifically configured to translate text from Spanish to English. Document mechanism 225 may invoke translation mechanism 227 via an application program interface (“API”) and pass the Spanish text to translation mechanism 227, while receiving the English language text in return. Similarly, translation mechanism 227 may be specifically configured to provide computer instructions based on NLTI.

In yet another preferred embodiment of the present invention, translation mechanism 227 may be configured to translate spoken words and commands into computer instructions that may, in turn, be used to process one or more documents. Additionally, translation mechanism 227 may be configured to translate audio commands into computer language processing instructions. For example, if a user creates an audio file containing document processing instructions (e.g., .wav, .mp3, files, etc.) that is associated with the message, translation mechanism 227 will process the audio file and convert the sound into natural language text instructions which are then treated as document processing instructions. Those skilled in the art will recognize that translations mechanism 227 may be a separate mechanism or, in certain preferred embodiments, may be integrated with document mechanism 225.

NLTI command dictionary 228 is a specialized dictionary that is used to interpret the NLTI provided by the user in a message. NLTI command dictionary 228 is a user configurable dictionary that may be expanded and modified as necessary for a specific application. Specialized commands may be included in various modules that have been adapted for specific workflow environments (e.g. medical, legal, etc.). After extracting the NLTI from the message, the textual content in the message will be compared to the commands stored in NLTI command dictionary 228 to determine the appropriate tasks to be performed for a document. As with translation mechanism 227, NLTI command dictionary may be a separate mechanism or may be incorporated as part of document mechanism 225.

In order to process NLTI instructions for various document processing needs, system 100 will include a series of pre-programmed commands. Some examples are shown below. Those skilled in the art will recognize that these examples are non-exhaustive and other equally relevant commands may be included.

Some examples of the NLTI processing instructions are shown below.
All phrases are not case sensitive except for passwords.
Multiple instructions should be separated by commas, semicolons, periods or entered on new lines.
Passwords must be enclosed within single quotes for example: ‘xyz123ismypw’

Some sample NLTI “save as” phrases are shown below.
Save to PDF
Convert as PDF
Save to TIF
Save to TIFF
Publish to PDF

Some sample NLTI file renaming phrases are shown below.
Save as the first barcode and todays date
Save using the time now and 3rd barcode
File name is the page number and todays date
Save to the mined invoice number
Save2PDF

Some sample NLTI security phrases are shown below.
Encrypted as ‘test’
Password protect using ‘test123’
Add a password ‘mypassword’
Secure with the password ‘test’

Some sample NLTI document stamping instructions are shown below.
Stamp each page with ‘confidential’
Add Bates stamping to each page

Some sample NLTI barcode naming phrases are shown below.
Use the first barcode
Rename with the second barcode
Save as the 2nd barcode string
Rename to the barcode
Rename as barcode 3
Remove separation sheets
Exclude barcode pages
1D Barcodes
2D Barcodes

Some sample NLTI data mining phrases are shown below.
Find the regular expression <regex string>
Split using the Regular Expression

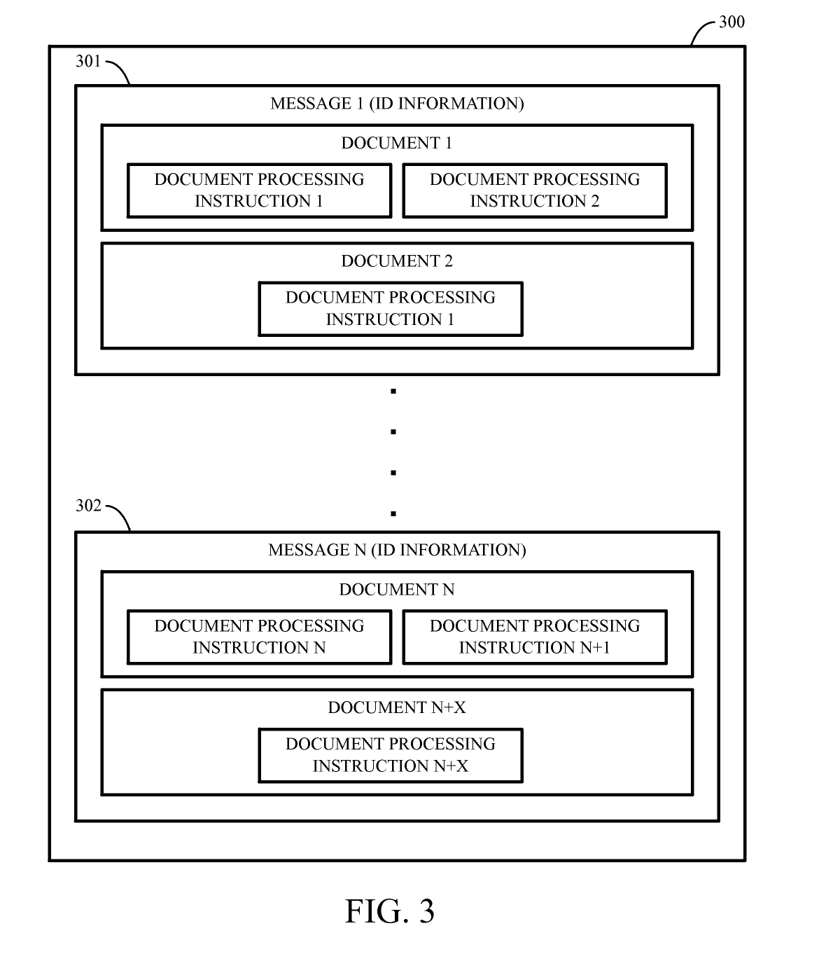

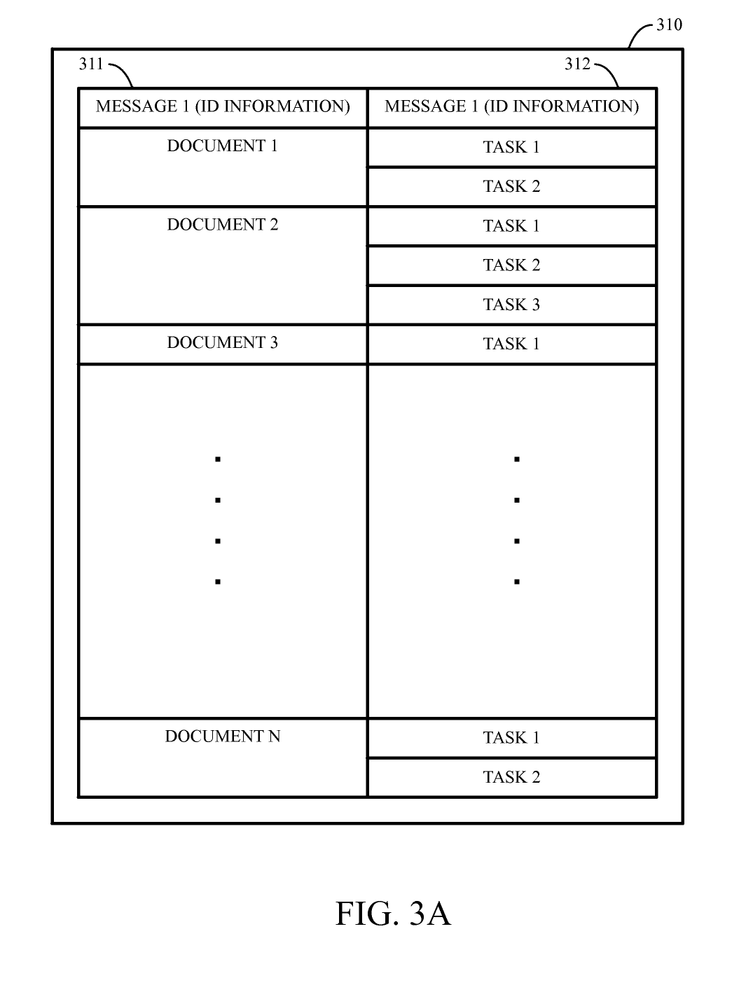

Referring now to FIG. 3, a schematic diagram of a message processing queue 300 containing one or more documents scheduled for processing using natural language instructions in accordance with a preferred exemplary embodiment of the present invention is depicted. As shown in FIG. 3, message processing queue 300 contains a plurality of documents that have been received by data server 130 of FIG. 2. Message processing queue 300 will typically reside in the addressable memory space of data server 130.

For this example, message processing queue 300 contains a message 301 and a message 302. Each of message 301 and message 302 may contain one or more documents and each document may have one or more processing instructions associated with it. In this example, message 301 comprises a message 1 and a message 2. Message 1 contains document 1 and document 2 and each of document 1 and document 2 comprise one or more document processing instructions. Server 130 will process the messages contained in message processing queue 300 and execute the appropriate document processing instructions for each document.

Additionally, as shown in FIG. 3, each message may also comprise message ID information that may include a date/time stamp, message originator identification and contact information, etc. This information allows for tracking of a message and reporting on the document processing activities back to the user that originated the document processing. The message ID information can be correlated with the user account information stored in database 223 of FIG. 2.

In the most preferred embodiments of the present invention, each document associated with a message will typically include one or more document processing instructions, directing document mechanism 225 of FIG. 2 to take certain steps to process the document. Document processing instructions may be instructions such as “convert the document to text,” “remove blank pages from document,” “translate the document to Spanish,” “password protect the document with the password xxx123,” “email the document to johnsmith@gmail.com,” etc. Each document may have multiple document processing instructions or a single document processing instruction.

Document mechanism 225 will process each document in message queue 300 in turn, depending on the configuration of message queue 300 and any user configurable processing protocol that has been established. For example, the operator of the SAAS may implement a “first in first out” prioritization scheme based on the time of arrival, a prioritization scheme based on user identification, user status (e.g., paying user vs. demo user), message priority, etc.

Referring now to FIG. 3A, a schematic diagram of a message processing queue 310 containing one or more documents scheduled for processing using natural language instructions in accordance with a preferred exemplary embodiment of the present invention is depicted. As shown in FIG. 3, message processing queue 310 contains a plurality of documents that have been received by data server 130 of FIG. 2. The documents are stored in a message queue 311 and Message processing queue 300 will typically reside in the addressable memory space of data server 130.

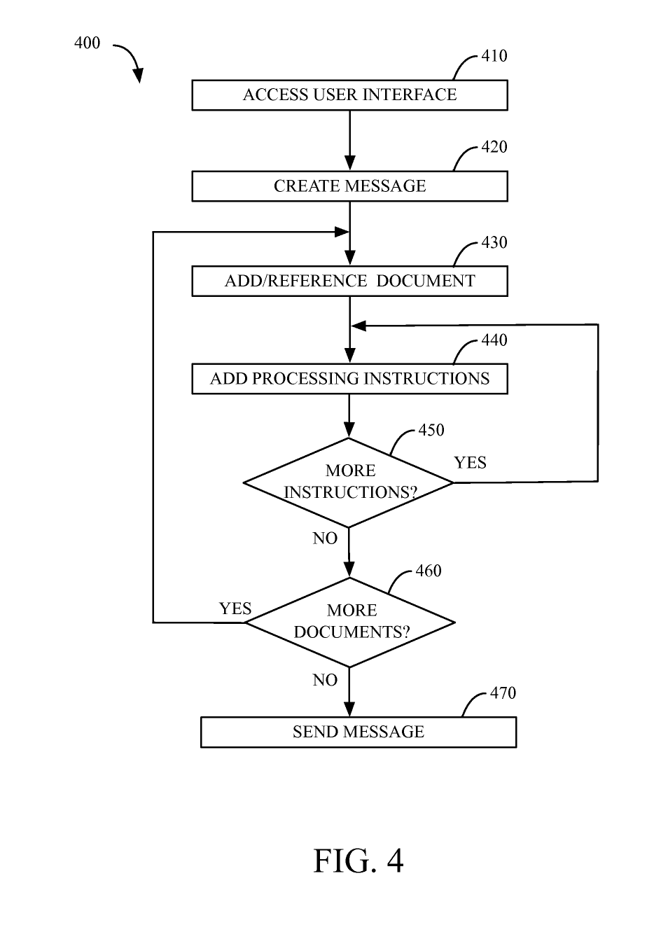

Referring now to FIG. 4, a flow chart for a method 400 or preparing a document for processing using natural language instructions in accordance with a preferred exemplary embodiment of the present invention is depicted. As shown in FIG. 4, a user will access a user interface (step 410) in order to prepare one or more documents to server 130 of FIG. 1. The user interface may be a web browser user interface associated with a SAAS website, it may be a user interface associate with a mobile “app” deployed on a smart phone, or any other user interface that allows a user to create a message (e.g., text input from a keyboard, voice or speech recording, etc.), attach a document to the message or reference a document in the message, and provide NLTI for processing the document.

Next the user will create or prepare a message (step 420). This may be an email message, an SMS message, or some other message. Next, the user will add a document to the message (step 430). The step of adding a document to the message may comprise adding an attachment to the message or providing a link or other indicator that references a specific location where the target document may be found and accessed for processing. For each document identified in or attached to the message, the user will provide processing instructions (step 440). If more than one instruction is desired (step 440=“YES”), then the user will continue to add processing instructions for the selected document. Once all documents have been added, the user will have the option of adding another document to the message. If another document is to be added (step 460=“YES”) then another document will be added and the processing instructions for the document will be added as well. This process will continue until all desired documents have been added and all processing instructions for the attached or referenced documents have been added at which point the message will be sent off to data server 130 of FIG. 2 for processing.

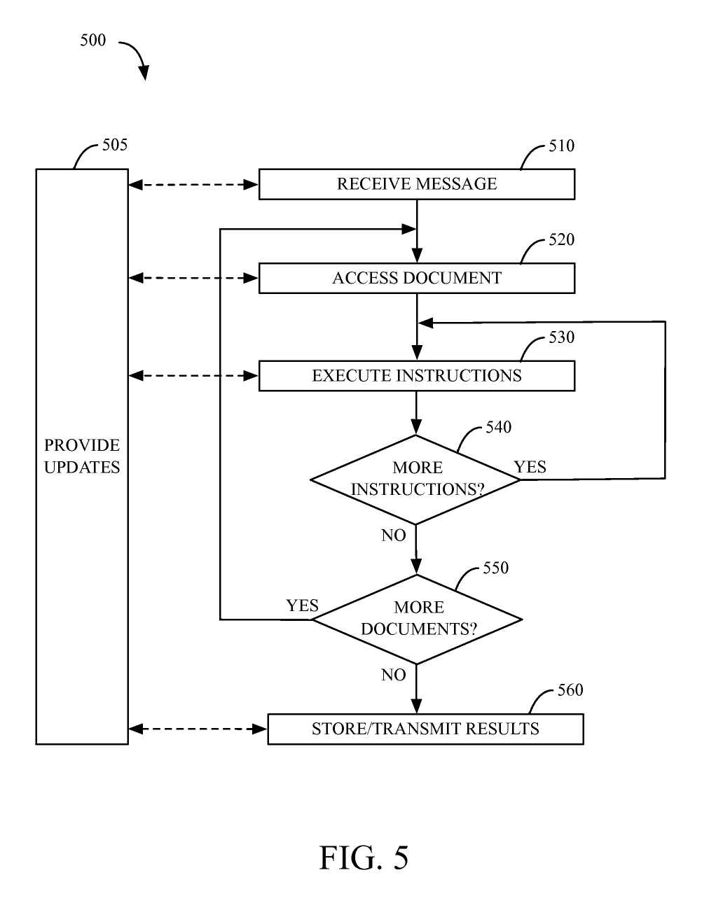

Referring now to FIG. 5, a flow chart for a method 500 for processing a document using natural language instructions in accordance with a preferred exemplary embodiment of the present invention is depicted. As shown in FIG. 5, after a message is received (step 510), the document or documents attached to or referenced by the message can be accessed (step 520) and the associated NLTI instructions can be extracted from the message, interpreted, and executed (step 530). If there is more than one processing instruction associated with a document (step 540=“YES”) then the instructions will be systematically executed until all processing instructions for that document have been completed. Similarly, if the message references multiple documents or if multiple documents are attached to the message (step 550=“YES”) then the subsequent documents will be processed in like manner and the results may be stored or transmitted (step 560). Additionally, it should be noted that at any point in the process, the message originator may be notified with one or more updates regarding the status of the document processing (step 505).

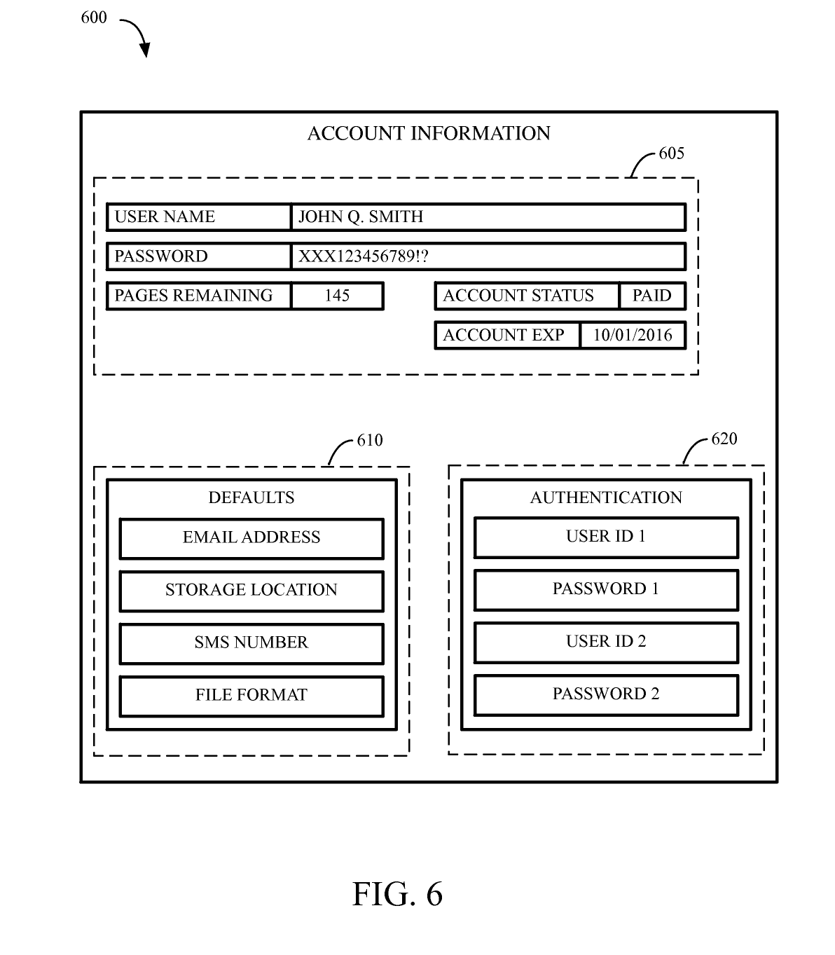

Referring now to FIG. 6, a database record 600 for a user account in a system for processing a document using natural language instructions in accordance with a preferred exemplary embodiment of the present invention is depicted. As shown in FIG. 6, a user account may contain user account information 605 that comprises information such as the user's name, password, account status, account expiration date, page count, etc. This provides options for various billing profiles to be included in a user account.

For example, a user could have a time-based account where the user pays for access to system 100 for a specific period of time (e.g., a month or a year). In addition, the user may have an account that is based on page count for documents processed by system 100. In this scenario, a user would pre-pay for a specific number of pages to be processed and as documents were processed, the number of pages remaining to be processed could be indicated by a countdown counter and the user could “replenish” the page count by buying more pages.

In addition, in at least some preferred embodiments of the present invention, the user may specify one or more defaults 610 that will provide for faster and more efficient processing of documents. In this embodiment, the user may specify a default email address, a default storage location, a default SMS number, and a default file format. Without being required to add any additional instructions, an email with document attachments sent to system 100 could use the default parameters to process the document, store in the desired format (e.g., PDF) and in the desired storage location (e.g., Dropbox), all without any specific information from the user. The user could override the defaults by specifying a new NLTI in the body or title of the email message (e.g., the NLTI may specify the file format JPG which would override the default PDF file format).

Similarly, the user could provide authentication credentials 620 for one or more third party document storage and processing services so that system 100 could access the third party services and process or store the documents as specified in the NLTI contained in the body or title of the message to which the documents are attached or which are referenced by the message.

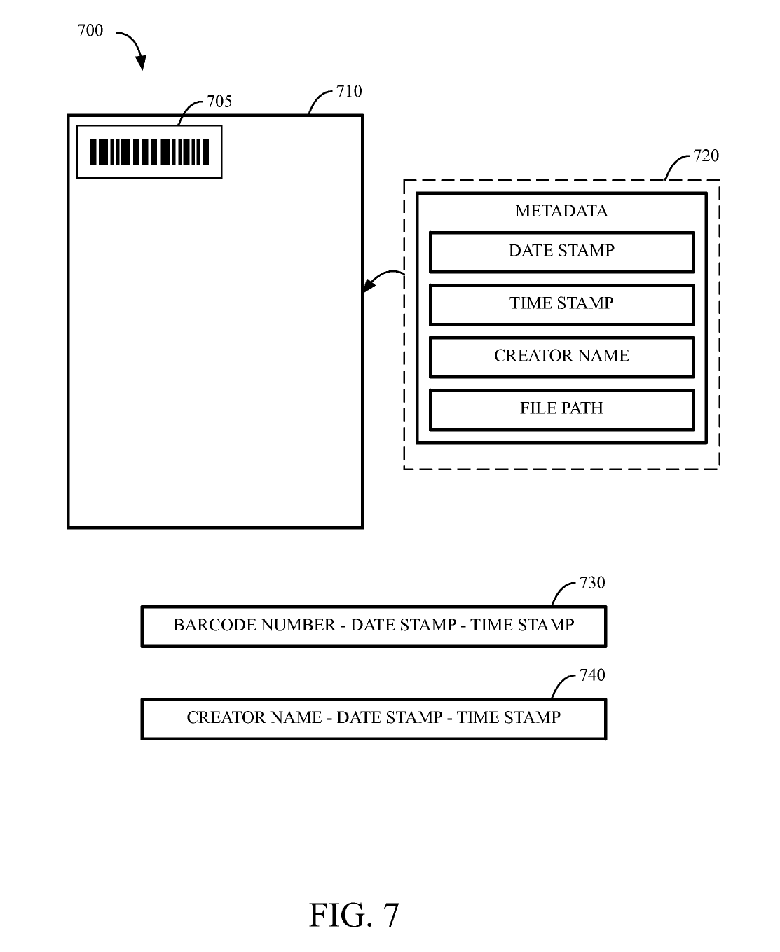

Referring now to FIG. 7, a document naming schema 700 for use in a system for processing a document using natural language instructions in accordance with a preferred exemplary embodiment of the present invention is depicted. As shown in FIG. 7, a document 710 comprises a bar code 705 and document associated metadata 720. Metadata 720 comprises any metadata associated with document 720, whether automatically generated (e.g., date and time stamp), extracted from the document content (e.g., data mined, generated by optical character recognition, text and expression parsing, etc.), or user generated (e.g., name and file path). As document 710 is being processed, system 100 will name the resulting file in accordance with the default processing instructions or the NLTI associated with the message used to transmit document 710 to system 100.

For example, the user could specify that the name for document 710 should comprise a concatenation of the barcode number, the date stamp, and the time stamp associated with document 710. This would result in a file name 730. Similarly, the user could specify that the name for document 710 should comprise a concatenation of the creator name, the date stamp, and the time stamp associated with document 710. This would result in a file name 740. Those skilled in the art will recognize that the naming conventions are too numerous to specify in detail and that any combination of document related metadata could be used to create a name for document 710 and other similar documents.

Finally, as previously mentioned, it should be noted that a document that has been identified for processing in a message may be an attachment to the message or, in some preferred embodiments of the present invention, may be simply referenced in the body of the document (e.g., via hyperlink, or reference to a particular file name or storage location in the file structure).

As will be appreciated by one skilled in the art, aspects of the computer-based system disclosed herein may be embodied as a system, method or computer program product. Accordingly, aspects of the computer-based system may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the computer-based system may take the form of a computer program product embodied in one or more computer readable medium(s) having computer readable program code embodied thereon.

Any combination of one or more computer readable medium(s) may be utilized. The computer readable medium may be a computer readable signal medium (transitory or non-transitory) or a fixed computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the computer-based system may be written in any combination of one or more programming languages, including an object oriented programming language such as objective C (C#), Visual Basic, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

From the foregoing description, it should be appreciated that computer-based system 100 and associated method for document processing disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A computer-based system comprising:
at least one processor;
a memory coupled to the at least one processor; and
a document mechanism residing in the memory, the document mechanism being executed by the at least one processor, wherein the document mechanism:
identifies at least one document for processing;
identifies at least one natural language text instruction for processing the at least one document; and
submits the at least one document and the at least one natural language text instruction for processing the at least one document to a cloud-based document processing system.

2. The computer-based system of claim 1 wherein the at least one document is at least one of a document attached to an email message and a document identified by a uniform resource locator.

3. The computer-based system of claim 1 wherein the at least one natural language text instruction comprises at least one natural language text instruction extracted from an audio file.

4. The computer-based system of claim 1 further comprising:
an input submitting device, the input submitting device comprising a display screen; and
a graphical user interface displayed on the display screen of the input submitting device, wherein a user interacts with the graphical user interface to:
identify a document for processing;
input at least one natural language text instruction for processing the at least one document; and
submitting the at least one document for processing to a cloud-based document processing system.

5. The computer-based system of claim 1 further comprising a database, the database comprising a plurality of user profiles, each of the plurality of user profiles comprising:
a plurality of information about a user; and
a plurality of default settings, the plurality of default settings comprising at least:
a default document storage location;
user authentication credentials; and
default page processing instructions.

6. The computer-based system of claim 1 further comprising a natural language text instruction dictionary, the natural language text instruction dictionary comprising a plurality of document processing commands.

7. The computer-based system of claim 1 further comprising a message processing queue, the message processing queue comprising:
a plurality of messages to be processed, each of the plurality of messages to be processed comprising:
at least one natural language text instruction associated with each of the plurality of messages to be processed; and
a plurality of metadata associated with each of the plurality of messages to be processed; and
a user configurable document processing protocol, the user configurable processing document protocol describing a processing order for processing the plurality of messages to be processed.

8. The computer-based system of claim 1 further comprising a document naming schema wherein at least a portion of a document name comprises at least one metadata item extracted from a plurality of metadata associated with the document, the at least one metadata item being extracted from the plurality of metadata in response to a natural language text instruction.

9. The computer-based system of claim 1 wherein the at least one natural language text instruction for processing the at least one document comprises:
a set of natural language constructs, the set of natural language constructs associating a plurality of document service semantics with the natural language constructs;
a plurality of document service settings; and
delivery instructions for the at least one document.

10. A computer-implemented method comprising the steps of:
creating a message;
including at least one natural language text instruction with the message, the at least one natural language text instruction comprising at least one document processing instruction;
identifying a document to be processed using the at least one document processing instruction;
transmitting the document and the at least one natural language text instruction to a cloud-based document processing system; and
processing the document using the at least one document processing instruction.

11. The computer-implemented method of claim 10 wherein the step of creating a message comprises the step of creating at least one of an email message and a text message.

12. The computer-implemented method of claim 10 wherein the step of identifying a document to be processed using the at least one document processing instruction comprises the step of attaching the document as an attachment to at least one of an email message and a text message.

13. The computer-implemented method of claim 10 wherein the step of identifying a document to be processed using the at least one document processing instruction comprises the step of including a uniform resource locator identifying the document in at least one of an email and a text message.

14. The computer-implemented method of claim 10 further comprising the steps of:
receiving user credentials associated with the document, the user credentials identifying a user;
authenticating the user with the user credentials and accessing a user profile associated with the user;
evaluating access rights for a user to process the document based on the user profile;
determining an appropriate charge for processing the document based on the user profile; and
accessing the user profile to determine at least one default processing instruction for processing the document.

15. The computer-implemented method of claim 10 wherein the step of including at least one natural language text instruction with the message comprises at least one of the steps of:
including a first natural language text instruction in the subject line of an email message; and
including a second natural language text instruction in the body of the email message.

16. The computer-implemented method of claim 10 further comprising the step of sending at least one notification message to the user, the at least one notification message comprising at least one of a status update, an authentication message, a billing message, delivery message, and an error message.

17. The computer-implemented method of claim 10 wherein the document is an encrypted document.

18. The computer-implemented method of claim 10 wherein the step of including at least one natural language text instruction comprises the steps of:
digitizing a human voice to create a digital audio file;
processing the digital audio file to extract at least one natural language processing instruction from the digital audio file; and
processing the document in accordance with the natural language processing instruction.

19. The computer-implemented method of claim 10 further comprising at least one of the steps of:
translating the at least one natural language text instruction from a first language to a second language; and
programmatically accessing a digital thesaurus to determine a meaning for at least one word in the at least one natural language text.

20. The computer-implemented method of claim 10 wherein the natural language text instructions comprise at least one reference to an object on a web page, the object describing at least one of a document location and a document processing instruction for processing a document identified by the document location.
